(19) United States
(12) Patent Application Publication
(10) Pub. No.: US 2016/0118835 A1
(43) Pub. Date: Apr. 28, 2016

(54) METHOD AND APPARATUS FOR OPTIMALLY LOCATING A DEVICE TO BE CHARGED IN A CHARGING AREA OF A WIRELESS CHARGER

(71) Applicant: MOTOROLA SOLUTIONS, INC., Schaumburg, IL (US)

(72) Inventors: DIPTI V, DESAI, LAWRENCEVILLE, GA (US); JOHN E. HERRMANN, SUWANEE, GA (US); MARK J. TERRANOVA, ALGONQUIN, IL (US)

(21) Appl. No.: 14/524,533

(22) Filed: Oct. 27, 2014

(51) Int. Cl. H02J 7/02

(52) U.S. Cl. CPC H02J 7/025

(57) ABSTRACT

A wireless charger facilitates positioning of a device or devices to be charged by the wireless charger in an optimum location relative to the wireless charger. Some embodiments use physical exclusion features to prevent placement of a device at minimum intensity positions in a charging field. Some embodiments use graphical indicia to indicate the relative charging field strength (or field strength indicators such as charge current, wattage etc.) at various positions so that the user can select an appropriate position. Some embodiments facilitate communication between the wireless charger and the device, where the wireless charger maintains a record of the devices being charged and their positions, in order to recommend a charging position.

### FIELD OF THE DISCLOSURE

The present disclosure relates generally to contactless or wireless chargers that provide a charging field for wirelessly charging a battery in a device placed in the charging field, and more particularly to optimally locating a device to be charged in the charging area of the wireless charger.

### BACKGROUND

Contactless or wireless charging is used as an alternative to wired charging where the device or battery of the device is either connected to a charging cable or placed in a charger pocket of a charger. Wireless charging offers the convenience of simply placing the device to be charged (meaning the battery of the device) in the charging area of the wireless charger. There is no need to connect a cable or orient the device to fit within a charger in any particular way. A wireless charger based on magnetic resonance provides a charging field in a charging area of the wireless charger. The charging field is a time varying electromagnetic field produced from a charging coil of the wireless charger. Typically the charging coil is designed to have a resonance at a frequency that facilitates energy transfer through electromagnetic coupling and is driven at the resonant frequency by the wireless charger to produce a wireless charging power signal as the charging field. Each device to be charged contains a receiving coil that is also resonant at the resonant frequency of the charging coil, or which can be controlled to have a resonance within a resonance bandwidth of the wireless charging power signal. This is different from wireless power transfer via magnetic induction, where the device with the receiving coil has be tightly coupled and specifically aligned with the charging coil.

By providing a charging field, rather than a limited number of charging cables or charging pockets in a charger, a wireless charger, based on magnetic resonance, can be used to charge several devices without the additional cost of charging connectors or contacts. However, in a charging field there are typically locations of low field intensity and locations of peak field intensity. Placing multiple devices in a charging field can lead to the devices being charged at different rates, or potentially not being charged at all, due to differences and even “null” spots (locations with insufficient field intensity) in the charging field. Furthermore, given that different types of devices can be placed together in a charging area of a wireless charger, without an awareness of the location of different field intensity locations, a device having a relatively high charge rate (i.e. having a relatively high capacity battery) can be inadvertently placed in a low charging field intensity position while a device having a relatively low charge rate (i.e. having a small capacity battery) can be inadvertently placed in a high or peak charging field intensity position, which is an inefficient use of the charging resource. Additionally, in a wireless charger with multiple charging (transmitting) coils, the charging field generated by different coils can cancel each other out in certain areas, depending on the location of the coils. Accordingly, the resulting charging field can have locations with insufficient field intensity (e.g. “null spots”) where the receive coil in a device would not produce sufficient current to charge the battery of the device.

Accordingly, there is a need for a method and apparatus for optimally locating a device to be charged in the charging area of a wireless charger.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a wireless charging system, in accordance with some embodiments;

FIG. 2 is a top view of a surface having a resonant charging coil, and the location of minimum intensity points, in accordance with some embodiments;

FIG. 3 is a isometric view of a wireless charger having multiple coils arranged in different planes, in accordance with some embodiments;

FIG. 4 is an isometric view of a wireless charger having exclusion features in accordance with some embodiments'

FIG. 5 is a top view of a wireless charger having exclusion features, in accordance with some embodiments;

FIG. 6 is a top view of a wireless charger surface the includes graphical indication of the relative strength of the charging field at various locations on the charging surface, in accordance with some embodiments;

FIG. 7 shows a wireless charger and a device to be charge in communication where the wireless charger determines an optimal location for locating the device in a charging region of the wireless charger, in accordance with some embodiments;

FIG. 8 is a flow chart diagram of a method for optimally locating a device to be charged in a charging region of a wireless charger, in accordance with some embodiments; and

FIG. 9 shows charging hooks on the wall of a wireless charger for hanging devices to be charged in specific locations.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Embodiments generally relate to wireless chargers and include a wireless charger having a wireless charging power signal generator, and at least one resonant charging coil coupled to the wireless charging power signal generator. The resonant charging coil or coils produce an electromagnetic charging field in a charging area of the wireless charger. The charging field has at least one minimum intensity position in the charging area, and the wireless charger further includes a physical indication of the at least one minimum intensity position in the charging area. The physical indication can be a graphical indicia, an exclusion feature, or any other physical indication that informs a user as the location of the minimum field intensity location(s) or which prevent a user from placing a device to be charged at the minimum field intensity location.

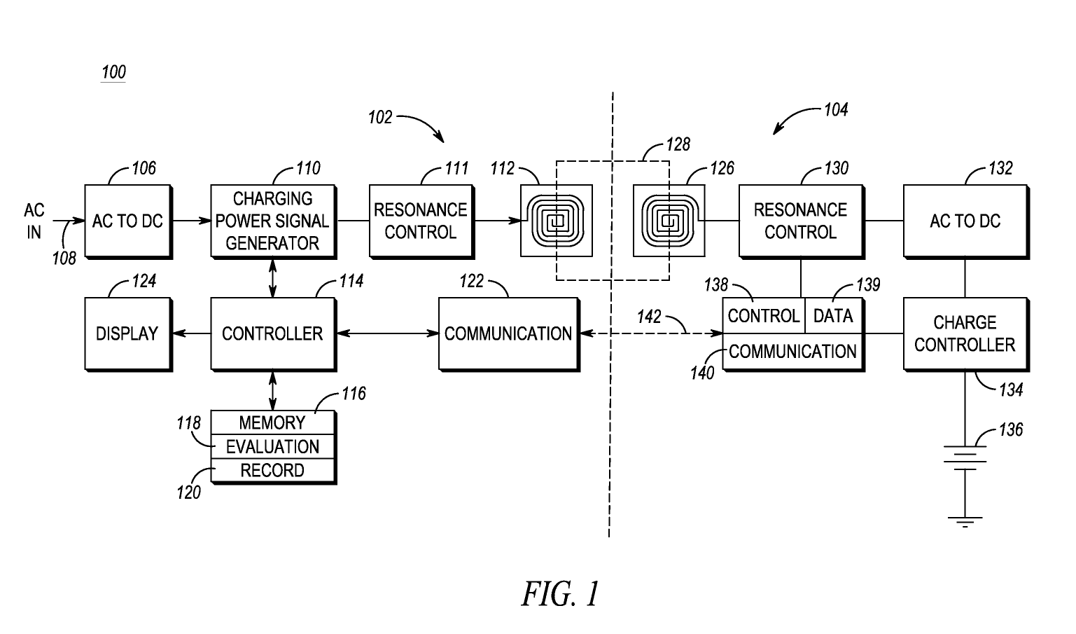

FIG. 1 is a block diagram of a wireless charging system 100, in accordance with some embodiments. The wireless charging system 100 includes a wireless charger 102 and a device 104, including a battery, to be charged. As used herein, phrases such as “charging the device” refer to charging a rechargeable battery, battery cells, or battery pack that is connected to, and is used to power the device. The device can be any portable device which uses a rechargeable battery and is otherwise designed in accordance with the teachings herein.

The wireless charger 102 includes can include an alternating current (AC) to direct current (DC) conversion circuit or regulator that converts a commercial AC source 108 to a desired DC voltage level. In some embodiments the wireless charger 102 can alternatively be powered by a DC source, such as, for example, a 12 volt DC source (e.g. a vehicular electrical output). Among the circuits powered by the output of the AC to DC conversion circuit 106, or a DC input, is a charging power signal generator 110 which generates a charging power signal that is used to drive a charging coil 112. The charging power signal is matched to the charging coil 112 by a resonance control circuit 111 which efficiently couples the output of the charging power signal generator 110 to the charging coil 112. The charging coil 112 is a resonant coil, which can be a planar coil, and is typically a spiral which can be formed in a plane or another type of coil (e.g. a conductor such as Litz wire) and which can be wound around magnetic material or simply an air coil, under a charging surface. Several such resonant charging coils can be used, and can be co-planar with each other but located at different areas of a charging surface. Additional coils can also be oriented in different planes in some embodiments. When driven with the charging power signal from the charging power signal generator 110, the charging coil 112 produces a charging field in a charging area of the wireless charger 102. When a device such as device 104 is placed in the charging area, it receives energy from the charging field and converts it into a DC current to charge its battery. In some embodiments the charging power signal can be a substantially sinusoidal signal having a frequency on the order of 6.78 MHz. In some embodiments the charging power signal can be at a different frequency.

Accordingly, the device 104 includes a receiving coil 126 to receive a portion of the energy in the charging field, and is thereby loosely coupled 128 to the charging coil 112. The device 104 can further include a resonance control circuit 130, like resonance control circuit 111, that optimizes the resonance of the receiving coil 126 to match the frequency of the charging power signal to efficiently couple the energy from the receiving coil 126 to the subsequent stage. The output of the receiving coil 126 and the resonance control circuit 130 is an AC waveform which is converted to DC by an AC to DC converter 132. The DC output of the AC to DC converter 132 is provided to a charge controller 134, which directs current through a battery 136 to recharge the battery.

The wireless charger 102 is configured to allow a user to optimally place the device 104 in the charging area of the wireless charger 102. This can be achieved in a variety of ways. In some embodiments the wireless charger 102 includes exclusion features that physically exclude devices from areas of minimum intensity of the charging field in the charging area. In some embodiments the charging area can have a surface in which one or more charging coils (e.g. charging coil 112) are located, and which includes graphical indications in different areas indicating different field intensity levels, allowing a user to match the charging need of the device with a position in the charging area that corresponds with the charging need. For example, a device using a very high capacity battery can be placed in an area marked as having the highest field intensity, while a device having a small rechargeable battery can be placed in an area of low field intensity.

In some embodiments the wireless charger 102 and the device 104 can communicate, and the wireless charger can direct the user to a location in the charging area to place the device for optimum charging in view of the charging needs of the device and the present charging activity (i.e. the presence of other devices being charged). Accordingly, the wireless charger 102 can include a controller 114 that controls the charging power signal generator 110, and can be coupled to a memory 116. The memory 116 can represent an aggregate memory that includes read only memory (ROM), random access memory (RAM), and other types of memory. The memory can be used to store both executable program code, such as a charging evaluation application program 118, and records 120 indicating which devices are being charged and their assigned location(s).

The controller 114 of the wireless charger 102 can be further coupled to a communication circuit 122 that is configured to send and receive wireless radio communication. In some embodiments the communication circuit 122 can be a wireless radio network interface controller that uses a standardized wireless network protocol, such as, for example that specified by the Institute of Electrical and Electronics Engineers (IEEE) and designated 802.11 or 802. 15. Standard 802.11 specifies protocols for wireless local area networking, commonly referred to as “WiFi,” while standard 802.15 includes protocols such as those known by the trade name BlueTooth. The device 104 can likewise include a controller 138 that is coupled to a communication circuit 140 that uses the same protocol and the communication circuit 122 in the wireless charger 102. The controller 138 can also have access to battery data, such as battery capacity, present state of charge, preferred charge rate, and so on. The device 104 can communicate relevant data 139 to the wireless charger 102 via communication circuits 122, 140. The controller, upon receiving the relevant data and a device identifier, can use the evaluation application program 118 to determine an optimal location at which to place the device in the charging area of the wireless charger 102. The results of the evaluation can be presented on a display 124 of the wireless charger 102, or transmitted to the device 104 for display on a display of the device (not shown), or both. Upon seeing the information on the display 124, or on the device 102, the user can then set the device in the indicated area in the charging area of the wireless charger 102. The wireless charger 102 also notes in the record 120 the device identifier and the recommend location in the charging area for optimal charging.

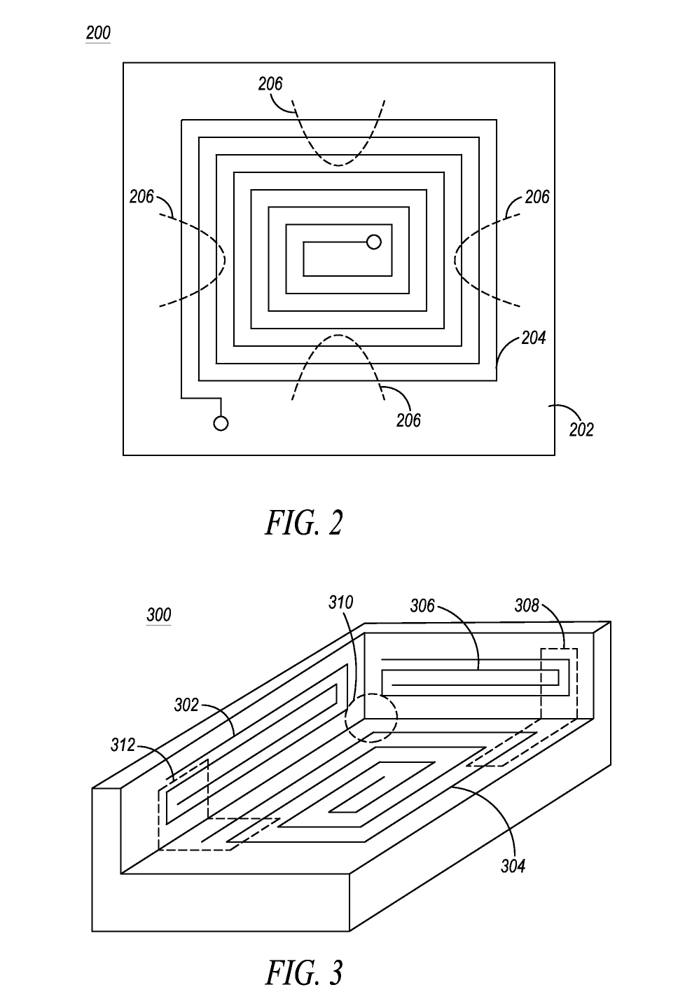

FIG. 2 is a top view 200 of a resonant charging coil 204, and the location of low or minimum field intensity points 206, in accordance with some embodiments. In particular, a single coil is shown, which will produce regions of relatively high field intensity and regions of relatively low field intensity. As used here, the term “low field intensity” or “minimum field intensity” refers to a field magnitude being below a threshold level deemed suitable for at least some type of charging, but which may be suitable for other types of charging (i.e. devices that require only low charging current or have relatively small batteries). The field magnitude can be determined by any of several parameters. For example, the Watts received at a device via the receiving coil, the resulting charging current in the device than can be produced from the receiving coil, the time it will take to charge a battery of a device, and so on. Any of these parameters, as well as the directly measured electromagnetic field magnitude, can be used to determine locations of low or minimum charging field intensity which are to be indicated by a physical feature or other indication. The charging coil 204 can be a planar resonant coil, and can be disposed adjacent to, and coplanar with a charging surface 202. The charging coil 204 can be one of several such coils used by a wireless charger and can be adjacent to a surface upon which devices are placed to charge them. As a result of the field produced by the charging coil 204, and any other charging coils of the wireless charger, there will be points of low intensity 206, meaning the magnitude of the charging field is at a relative minimum magnitude. In some embodiments these minimum intensity positions 206 are to be avoided. In some embodiments the minimum intensity positions 206 are used only for devices having very low charging requirements.

FIG. 3 is an isometric view of a wireless charger 300 having multiple coils arranged in different planes, in accordance with some embodiments. A first coil 304 can be located in a charging surface upon which devices are placed to be charged. A first coil 304 can be oriented to be substantially coplanar with the charging surface. A second coil 302 can be located in a first wall of the charger, which is perpendicular to the plane of the charging surface. A third coil 306 can be located in second wall that is perpendicular to both the first wall and the charging surface. Additional coils can be used as well, including multiple coils in the same surface/wall. As a result of having multiple coils, the interference pattern produced by the respective field contribution of each coil will produce minimum and maximum field intensity positions, as well as positions having intermediate intensities (i.e. a gradation of charging field intensity). For example, regions 308, 310, and 312 can represent regions of minimal field intensity. It should be noted that the locations shown here (308-312), as well as elsewhere in the drawings, are meant only to be exemplary of the existence of minimum or low field intensity locations, and not meant to imply the locations of actual minimal field intensity locations with respect to any particular implementation of a multiple coil wireless charging arrangement.

In addition to placing devices to be charged on the charging surface where the first coil 304 is located, devices can be placed outside of, but adjacent to the charger, to be charged by the field formed by the coils 302, 304, 306 outside of the charging surface. The charger 300 can facilitate optimally locating a device to be charged, such as by excluding devices from low intensity positions, or prioritizing devices by instructing a user to place a device to be charged at a position corresponding to the charging needs of the device.

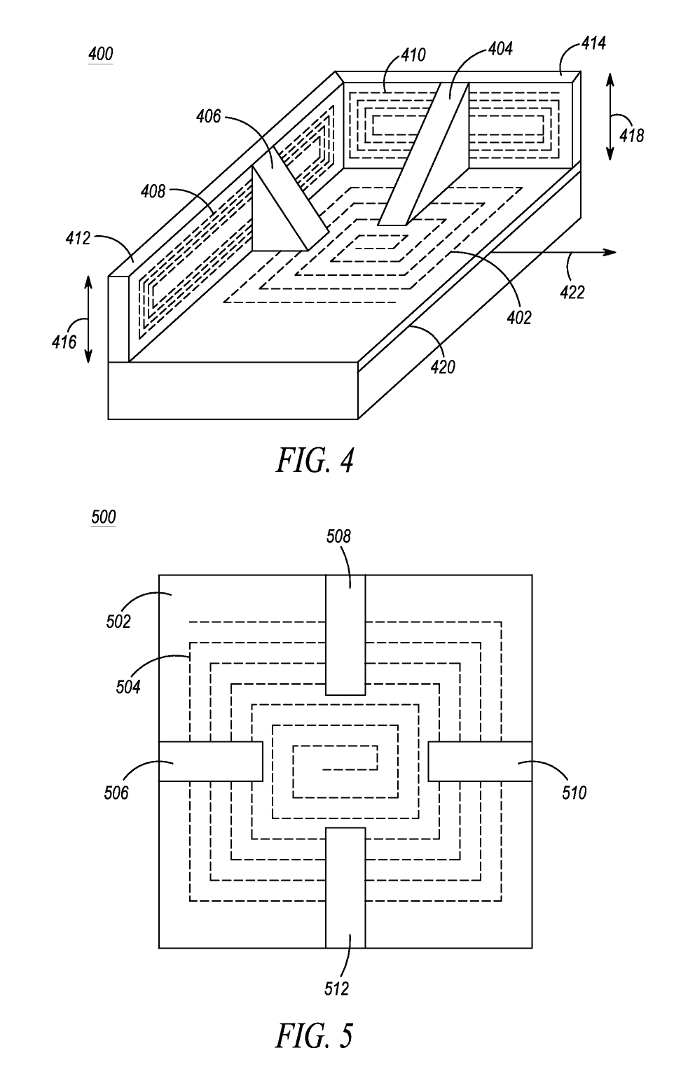

FIG. 4 is an isometric view of a wireless charger 400 having exclusion features in accordance with some embodiments. The charger 400 includes a charging surface under which a resonant charging coil 402 is disposed. Other charging coils 408 and 410 are located within the walls 412, 414, respectively, of charger 400. Devices can be placed on the surface (i.e. over charging coil 402) and receive energy from the charging coil 402 and charging coils 408, 410, which is converted in the device to a DC current and voltage that can be applied to charge a battery used to power the device. To exclude placement of a device at a minimum intensity position (created by interference of opposing fields from coils 402, 408 and 410), exclusion features 404, 406 are incorporated into the charger 400 on the charging surface so that a device cannot be placed at those locations. The exclusions features physically prevent placement of a device on the surface of the wireless charger 400 at the locations of the exclusion features 404, 406.

It is further contemplated that the wireless charger 400 can be expandable or reconfigurable, such as by, for example, the use of collapsible or extendable walls. For example, walls 412, 414 can be raised or lowered as indicated by arrows 416, 418, respectively. The walls 414, 416 are shown here in a raised and activated position, where, upon being raised into the position shown, the wireless charger 400 can activate charging coils 408, 410. In some configurations either of walls 412, 414 can be lowered to disengage their respective charging coil 408, 410, and the wireless charger 400 will only provide a charging power signal to charging coil 402 and whichever of charging coils 408, 410 that are activated by its respective wall 412, 414 being raised.

In addition to walls 412, 414 which can be selectively raised or lowered to engage or disengage charging coils 408, 410, respectively, a shelf 420 can be incorporated into the wireless charger 400. As shown here the shelf 420 is in a closed position under the surface in which charging coil 402 is disposed, and can be opened in the direction of arrow 422. The shelf 420, like walls 412, 414 can likewise contain an additional charging coil, and upon opening shelf 420 the horizontal surface area on which devices can be placed is increased. Accordingly, in some embodiments a wireless charger such as wireless charger 400 can include one or more movable members (e.g. a wall or a shelf) that includes an additional charging coil that is activated when the moveable member is in an open position (i.e. raised or extended), and which is deactivated by the wireless charger when the moveable member is in a closed position (i.e. lowered or closed).

FIG. 5 is a top view of a wireless charger 500 having exclusion features, in accordance with some embodiments. The wireless charger 500 can be similar to that shown in FIG. 4. A charging surface 502 has at least one charging coil 504 oriented in the plane of the charging surface 502. The charging coil 504 is energized or driven with a charging power signal to produce a wireless charging power signal in a charging field around the charging coil 504. Devices placed in the charging field can receive energy from the charging field using a receiving coil (i.e. as in FIG. 1), which can be used to charge a battery of the device as well as provide power to the device to operate the device while the battery of the device is being charged. In order to exclude devices from minimum intensity positions, exclusion features 506, 508, 510, and 512 are placed at the minimum intensity positions as barriers that prevent placement of a device at those locations.

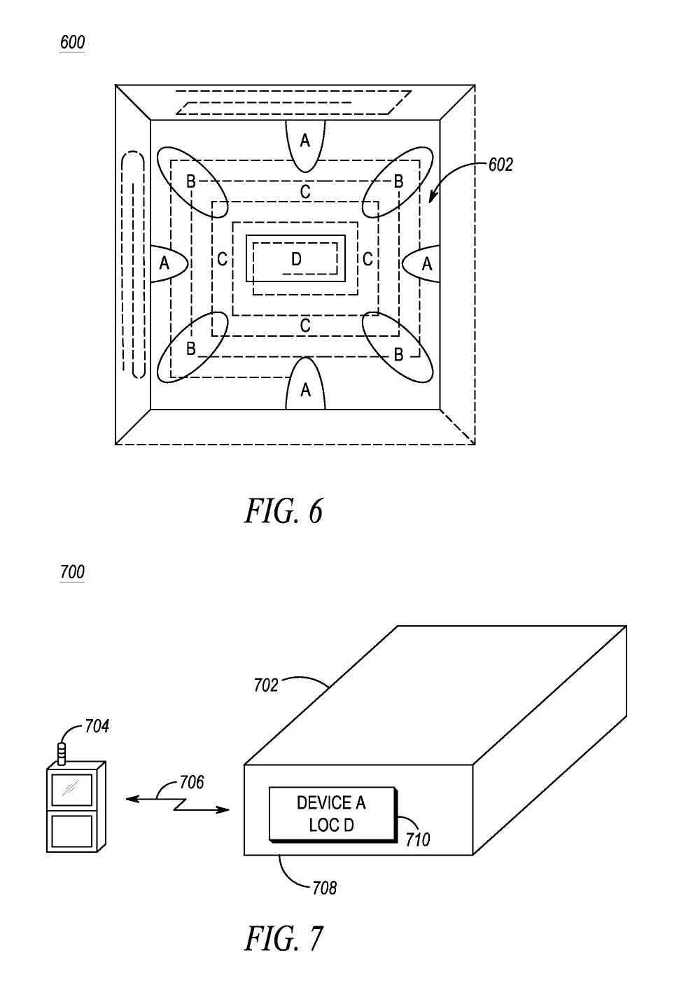

FIG. 6 is a top view of a wireless charger surface 600 that includes graphical indication of the relative strength of the charging field at various locations on the charging surface, in accordance with some embodiments. Whereas in FIGS. 4-5 physical exclusion features are used that prevent placement of devices at the minimum intensity positions, in some embodiments in accordance with that shown in FIG. 6 the charging surface 602 can include graphical indications as to the relative intensity of the charging field produced by the charging coil or coils. Graphical indicia on the charging surface 602 can indicate borders of various intensity regions as well as a label such as, for example, A-D, indicating, from lowest intensity to highest (maximum) intensity (e.g. charging current rates in Amperes or Milliamperes). Thus, as user can decide at which position to place a device to be charged. Devices with a very low charging rate can be placed at the “A” positions, while devices that require a high charging rate can be placed at the “D” position, and devices having intermediate charging rates can be placed at corresponding intermediate positions “B” and “C.” In some cases the “D” position may be entirely occupied with devices being charged when a user with another device that would optimally require placement at the “D” position needs to charge the device. In such a situation, the user can alternatively place the device in a “C” position until one of the devices in the “D” position is removed, making space available at the “D” position. It is contemplated that devices can have a similar indicia, A, B, C, or D, on an external surface or label of the device, or which can be displayed on a display of the device, to indicate to users the optimal position for placing the device on a wireless charger such as wireless charger 600.

FIG. 7 shows a wireless charger system 700 including a wireless charger 702 and a device 704 to be charged, in accordance with some embodiments. In FIG. 6 a charging surface having indicia of relative charging field intensity positions is shown, but it is up to the user to determine to which location a given device corresponds. The wireless charger 700 uses similar graphical indicia on a charging surface, but directs users as to the optimal location to place a given device. The wireless charger 702 and device 704 can be designed in accordance with that shown in FIG. 1. As such, the wireless charger 702 and device 704 can communicate over a channel 706 (wireless or wired). The device 704 can detect the presence of the wireless charger 702 by any known means, such as detection of a beacon transmission, being connected to the wireless charger, or by detection of a charging field. In some embodiments the wireless charging power signal can be modulated to provide an identifier that the device 704 can use to initiate communication with the wireless charger 702. Upon initiating communication, the device 704 transmits information indicating its charging requirements as well as an identifier to be used by the wireless charger 702 in subsequent communication with the device 704.

It is contemplated that the wireless charger 702 can be used to charge a plurality of devices which have different charging requirements (i.e. charging rates). Accordingly, it is desirable to organize device placement relative to the charger so that devices with high charge rate requirements are placed in positions with the highest charging field intensity, and devices with low charging requirements are placed in positions with low charging field intensity. The wireless charger can keep a record of device presence and location by periodically polling devices. In response to a poll, each device can affirm its presence, as well as a charging rate, and a state of charge. The charging rate can be used to infer its position (i.e. higher charge rates indicate higher intensity position). The state of charge indicates an approximate proportion, relative to a “full” charge, to which the device's battery is presently charged. In some embodiments the wireless charger can maintain a record for each device being charged that can include one or more of a state of charge, optimum charging parameters, a device charging priority, or an organizational identifier. The state of charge refers the present battery capacity, which can be determined by conventional means, such as by a “fuel gauge” circuit in the device or battery of the device being charged. The optimum charging parameters refers to the optimum charging current and/or voltage to be used in charging the battery of the device. The device charging priority refers to a designation that indicates whether a device has, for example, a high priority or a low priority for charging. Certain devices can be designated to have higher priority to address organizational needs, for example. The organizational identifier can be used to give higher priority to devices belonging to an organization having a higher priority status for scenarios where a wireless charger is used to charge devices belonging to several different organizations (e.g. a field-deployed wireless charger used to charger devices belonging to both police and fire/rescue organizations).

As devices reach full charge, they can be moved to lower intensity positions for maintenance charging, freeing up space for other devices that have higher charging requirements. Accordingly, when the device 704 communicates with the wireless charger 702, the wireless charger 702 evaluates the information transmitted by the device (i.e. data 139) to determine the optimum position to place the device 704 based on the charging requirements of the device 704 and the current load of devices already being charged by the wireless charger 702. The wireless charger 702 can, for example, indicate on a display 708 the device 704 identifier and its presently assigned charging position 710. The wireless charger 702 can also indicate, if a position is not available, an amount of time until one of the device being charged will be fully charged and can be moved to lower intensity charging position for maintenance charging, or removed. Alternatively the wireless charger 702 can indicate an alternative location to place the device 704 temporarily to at least commence some charging until a position at a higher intensity position becomes available.

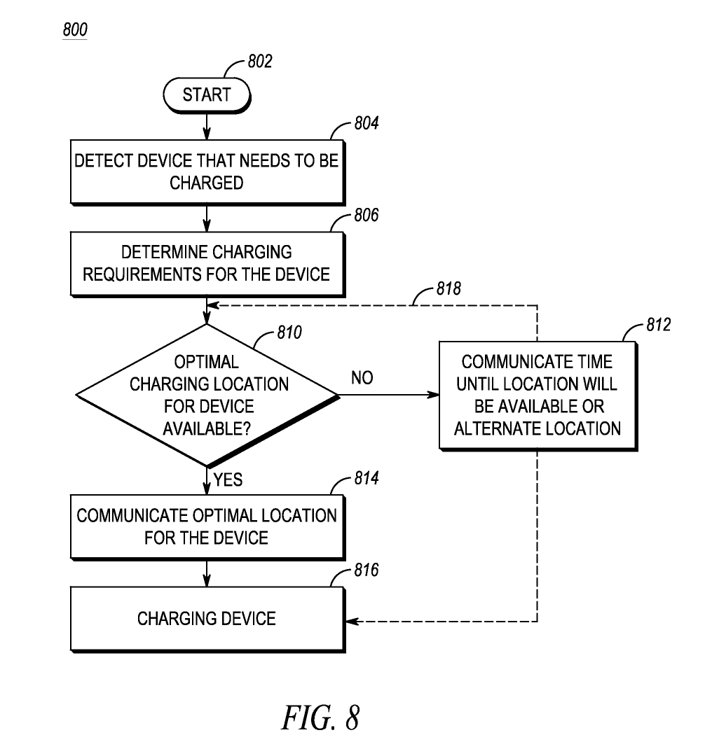

FIG. 8 is a flow chart diagram of a method 800 for optimally locating a device to be charged in a charging region of a wireless charger, in accordance with some embodiments. The method 800 can be implemented using a wireless charger and device(s) such as those exemplified in FIG. 1, and further illustrates operation of the wireless charger 702, and device 704 for FIG. 7. Thus, at the start 802 the wireless charger can be charging one or more devices, and a (new) device is brought into proximity with the wireless charger to be charged by the wireless charger. The wireless charger can detect the device in step 804, such as by the device initiating communication (automatically or in response to a manual operation by a user). In step 806 the device communicates information to the wireless charger that allows the wireless charger to determine the device's charging requirement, which indicates the best location at which to place the device for charging. In step 810 the wireless charger can determine whether the optimal location for charging the device is presently available, based on the present load of devices being charged. For example, a device that has a high capacity battery requiring a high rate of charge can be optimally located at position “D” of a charger configured in accordance with that shown in FIG. 6.

If the optimal position is not presently available, then the wireless charger in step 812 can communicate to the device the time until the optimal position will be available, or an alternative position to be used until space is available at the optimal position, or both. If the user places the device at an alternative position, then the device can commence being charged in step 816 at a sub-optimal charge rate. Otherwise, the method can loop back to step 810 via branch 818 to iteratively check to determine whether there is a space available at an optimum charging position for the device.

If in step 810 it is determined that there is presently space available at an optimal charging position in the charging area of the wireless charger, the wireless charger can communicate the position in step 814 (i.e. a label corresponding to a graphical indicia on the charging surface). And the device can then commence charging at an optimal rate. While charging the device, the wireless charger can periodically poll the device, and other devices being charged, to affirm their presence and their present state of charge for future iteration of the method 800 as new devices are processed by the method 800 for charging.

In embodiments that include moveable members such as those shown in FIG. 4, when an additional charging coil is activated by raising or extending a moveable member having a charging coil, the interference pattern will be changed. Likewise, when a movable member is lowered or closed, deactivating a charging coil in the moveable member, the interference pattern of the charging field will change. The interference patterns for each combination of activated and deactivated charging coils can be determined and used to by the wireless charger to determine an appropriate location for charging a given device. Accordingly, the charging field intensity at various locations of the wireless charger can change depending on which charging coils are active, and thus, the graphical indications on a charging surface can correspond to different charging field intensities based on the particular configuration of a configurable wireless charger. For example, a location having a minimum intensity with only one charging coil activated can become a high intensity location when two additional charging coils are activated such as upon raising two walls having charging coils. Accordingly, the wireless charger can determine a suitable charging location for a given device based on its charging requirements and also a present configuration of the wireless charger.

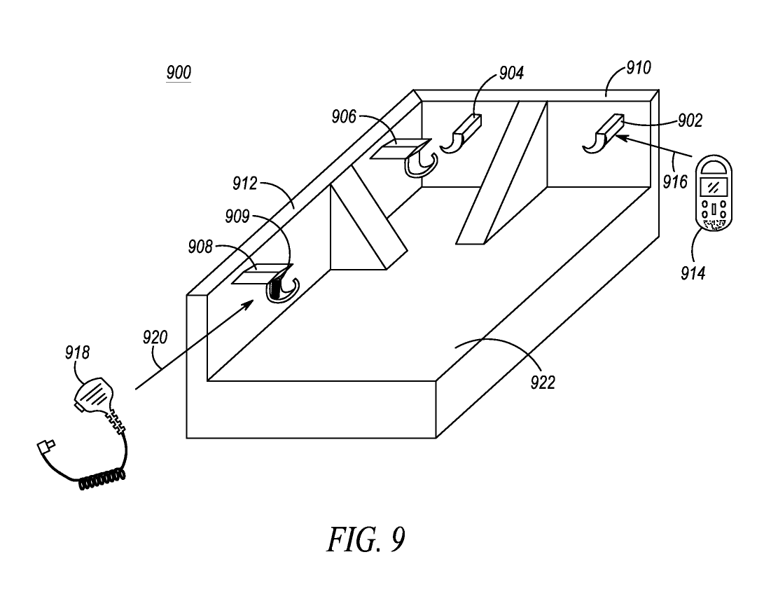

FIG. 9 shows charging hooks 902, 904, 906, 908 on vertical planes (walls) 910, 912 of wireless charger 900. These hooks can contain charging coils, such as charging coil 909 in hook 908 in some embodiments. In some embodiments the hooks (i.e. 902, 904, 906) can be passive (i.e. having no charging coil) and located at a location of a particular field intensity. These hooks can be used to conveniently hang devices to be charged. For example, a portable radio device 914 can be hung on hook 902, as indicated by arrow 916. A remote microphone assembly 918 for the portable radio device 914 can be hung on hook 908, as indicated by arrow 920. The receive coil within the device (or its battery) can pick up the charging field originating from the charging coil in a hook or from the charging coil residing within the vertical plane or the horizontal surface 922. It is further contemplated that the hooks can be located at different field intensity locations, or at equivalent field intensity locations. For example, passive hooks 902-906 can each be located at a low, medium, and high field intensity location, respectively, while in some embodiments hooks 902-906 can all be located at high charging field locations, or low charging field locations.

In some embodiments one or more of charging hooks 902, 904, 906, 908 can be located on an exterior surface of walls 910, 912 but within a charging field of the wireless charger. Furthermore, each charging hook 902, 904, 906, 908 can include a visual indicator such as an LED. Upon the wireless charger communicating with a device (e.g. 914, 918), the wireless charger 900 can, for example, illuminate or blink the visual indicator to indicate the charging hook on which the user should place the device so that the device can be charged. The determination of which charging hook 902, 904, 906, 908 to use can be made by the wireless charger 900 similar to determining a position on the charging surface 922. The determination and selection of a charging hook 902, 904, 906, 908 by the wireless charger 900 can happen automatically, without user action, upon the user bringing the device into communication proximity with the wireless charger 900. Depending on the number and location of different devices being charged at any given time, any given device may be assigned to different locations or charging hooks 902, 904, 906, 908 each time the wireless charger 900 determines a location for the device. In some embodiments where each of the charging hooks 902, 904, 906, 908 has its own charging coil, the power at which the charging coil of a particular charging hook is driven can be adjusted by the wireless charger 900 to suit the charging needs of a particular device assigned by the wireless charger to the particular charging hook. In some embodiments the charging hooks 902, 904, 906, 908 can be provided with a pressure sensing means to determine when a device has been hung on a charging hook to prompt the charger to commence providing a charging power signal to the charging coil of that particular charging hook.

Accordingly, embodiments provide the benefit of optimally locating devices in relation to a wireless charger for wireless charging. Some embodiments employ physical structure to exclude placement of devices in minimum or low intensity positions, and some embodiments provide graphical indicia of relative charging field intensity to allow placement of devices relative to the charger at locations that correspond with their charging requirements. In some embodiments the wireless charger can communicate with devices being charged to both inform devices as to the optimal location to place a device based on a present load on the charger of devices being charged and the device's charging requirements.

It will be appreciated by those skilled in the art that although embodiments shown and discussed herein have focused on wireless charging, a wireless charger can also provide, for example, one or more wired charging ports such as a universal serial bus (USB) port to which devices that are not equipped with a receiving coil and circuitry to facilitate wireless charging can be connected and charged. Furthermore. A wireless charger in accordance with the teachings herein can take on any variety of shapes, including having fold-out surfaces. Additionally, the wireless charger can be a repeater that is placed on a larger wireless charging surface, and which receives energy from the larger charger surface, and retransmits it using its own charging coils, but guides optimal location of devices to be charged in accordance with at least some embodiments herein.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In particular executable code generated from software instructions for a wireless charger, a portable device, or both, which when executed cause the wireless charger or portable device to function in accordance with the disclosure, can be embodied on such computer-readable storage media. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A wireless charger, comprising:
a wireless charging power signal generator;
at least one resonant charging coil coupled to the wireless charging power signal generator and which produces an electromagnetic charging field in a charging area of the wireless charger, the charging field having at least one minimum intensity position in the charging area; and
at least one indication of the at least one minimum intensity position in the charging area.

2. The wireless charger of claim 1, wherein the at least one resonant charging coil comprises a plurality of resonant charging coils located in different portions of the wireless charger, wherein each one of the plurality of resonant charging coils produces a charging field, the at least one minimum intensity position is formed by interference among the respective charging fields of the plurality of resonant charging coils.

3. The wireless charger of claim 2, wherein at least two of the plurality of resonant charging coils are oriented in different planes.

4. The wireless charger of claim 1, wherein the indication of the at least one minimum intensity position is an exclusion feature that prevents placement of a device to be charged at the at least one minimum intensity position.

5. The wireless charger of claim 1, wherein the indication of the at least one minimum intensity position comprises a hook mounted on a wall of the wireless charger, wherein the hook is mounted on either an internal surface of the wall or an exterior surface of the wall and within the charging field.

6. The wireless charger of claim 1, wherein the indication of the at least one minimum intensity position is a graphical indication on a surface in the charging area.

7. The wireless charger of claim 6, wherein the graphical indication further indicates at least one non-minimum intensity position in the charging area.

8. The wireless charger of claim 7, further comprising a communication circuit, wherein the wireless charger communicates with a device to be charged to receive device information from the device to be charged, and wherein the charger indicates a position to place the device to be charged among the at least one minimum intensity position and the at least one non-minimum intensity position in the charging area based at least in part on the device information.

9. The wireless charger of claim 8, wherein the wireless charger maintains a record for each of a plurality of devices being charged by the wireless charger and a position of each of the plurality of devices being charged by the charger, and wherein the position to place the device is based on the positions of the plurality of devices being charged.

10. The wireless charger of claim 9, wherein the record for each of the plurality of devices being charged includes at least one of a state of charge, optimum charging parameters, a device charging priority, or an organizational identifier.

11. The wireless charger of claim 1, wherein the wireless charger further comprises at least one collapsible member that includes a charging coil.

12. The wireless charger of claim 1, wherein the wireless charger can be powered from either a commercial AC source or a DC source.

13. The wireless charger of claim 1, further comprising at least one moveable member that includes an additional charging coil that is activated when the moveable member is in an open position and deactivated when the moveable member is in a closed position.

14. A method for wireless charging of a battery in a portable device, comprising:
detecting, at a wireless charger, the portable device;
receiving, at the wireless charger from the portable device, charging requirements for the portable device;
the wireless charger determining a charging location relative to a charging coil of the wireless charger based on the charging requirements; and
the wireless charger indicating the determined charging location.

15. The method of claim 14, wherein detecting the portable device comprises detecting the portable device via a wireless radio communication protocol.

16. The method of claim 14, wherein indicating the determined charging location comprises:
transmitting the determined charging location to the portable device; and
the portable device displaying the determined charging location.

17. The method of claim 14, wherein indicating the determined charging location comprises displaying the determined charging location on a display of the wireless charger.

18. The method of claim 14, wherein the wireless charger includes at least one moveable member having an additional charging coil, the determining the charging location further comprises determining the charging location based on a present configuration of the at least one moveable member.

19. A wireless charging system, comprising:
a wireless charger having at least one resonant charging coil that produces an electromagnetic charging field in a charging area of the wireless charger, the charging field having at least one minimum intensity position in the charging area, the wireless charger further having at least one physical indication of the at least one minimum intensity position in the charging area; and
a portable device having a battery and a receiving coil that receives energy from the resonant charging coil to recharge the battery.

20. The wireless charging system of claim 19, further wherein the physical indication of the at least one minimum intensity position comprises graphical indicia on a charging surface of the wireless charger.

21. The wireless charging system of claim 19, wherein the portable device communicates device information to the wireless charger and the wireless charger determines a position to place the portable device among the at least one minimum intensity position and the at least one non-minimum intensity position in the charging area based at least in part on the device information.

22. The wireless charging system of claim 21, further comprising:
a hook disposed on one or more of:
a wall of the wireless charger on either an interior or exterior surface of the wall within the charging field;
a wall exterior to the wireless charger within the charging field; and
wherein the hook includes a visual indicator to indicate that the portable device is to be hung on the hook as the determined position.
